(19) United States
(12) Patent Application Publication
(10) Pub. No.: US 2021/0325720 A1
(43) Pub. Date: Oct. 21, 2021

(54) LIQUID CRYSTAL DISPLAY PANEL AND MANUFACTURING METHOD OF SAME

(71) Applicant: TCL China Star Optoelectronics Technology Co., Ltd., Shenzhen (CN)

(72) Inventor: Yun YU, Shenzhen (CN)

(73) Assignee: TCL China Star Optoelectronics Technology Co., Ltd., Shenzhen (CN)

(21) Appl. No.: 16/620,886

(22) PCT Filed: Nov. 18, 2019
(86) PCT No.: PCT/CN2019/119098

§ 371 Date: Dec. 10, 2019

(30) Foreign Application Priority Data
Sep. 16, 2019 (CN) 201910871963.1

(51) Int. Cl. G02F 1/1335; G02F 1/1339; G02F 1/1341; G02F 1/1337

(52) U.S. Cl. CPC G02F 1/133512; G02F 1/133514; G02F 1/133788; G02F 1/1341; G02F 1/1339

(57) ABSTRACT

A liquid crystal display panel and a manufacturing method of same are provided. The liquid crystal display panel comprises: a first substrate; a second substrate disposed opposite to the first substrate; a liquid crystal layer disposed between the first substrate and the second substrate; a sealant bonding the first substrate with the second substrate and sealing the liquid crystal layer; and a light-shielding layer, wherein the light-shielding layer is located on a side of the second substrate away from the first substrate. The liquid crystal display panel comprises a display area and a non-display area, the light-shielding layer comprises a first part and a second part, the first part is located in the non-display area, and the second part is located in the display area.

### BACKGROUND OF INVENTION

### Field of Invention

This disclosure relates to the field of display, and particularly relates to a liquid crystal display panel and a manufacturing method of same, which can prevent display mura and abnormal display, as well as prevent an array substrate and a color filter substrate from stripping.

### Description of Prior Art

A thin film transistor liquid crystal display (TFT-LCD) includes an array substrate (also called TFT substrate), a color filter substrate (also called CF substrate), a liquid crystal (LC) layer, and a sealant. In a known TFT-LCD structure, a whole block of a black matrix (BM) is disposed in a non-display area on a side of the color filter substrate facing the liquid crystal layer to prevent light leakage so as to increase contrast ratio. During manufacturing, it is necessary to form the black matrix before bonding the array substrate and the color filter substrate, which brings the following problems.

(1) As the black matrix exists on the side of the CF substrate as a shield, light irradiation needs to be conducted from a side of the TFT substrate to cure the sealant. However, a large amount of metal circuits on the side of the TFT substrate is present, while line width of the metal traces can sometimes reach about 40 um. A light transmittance of a position which is coated by the sealant is low, thus affecting light curing of the sealant. Poor curing of the sealant will pollute liquid crystals, causing display mura and abnormal display of edge areas of the display area; for example, image retention, display mura, and so on. In addition, bonding ability of the sealant becomes weak, which easily leads to stripping of the array substrate and the color filter substrate.

(2) It is known that a vertical alignment (VA) display type is broadly used in large-size display panels. In a VA display in which color filter on array (COF) technology is applied, after a cell assembling step, light irradiation needs to be conducted to the liquid crystals to form a pretilt angle. Under this circumstance, it is necessary to conduct light irradiation through a substrate without TFT and CF. Incomplete reaction occurs to monomers inside the liquid crystal layer which are located in areas shielded by the black matrix, which generates free radicals, leading to an increase in number of free radicals in the liquid crystals and easily causing display mura and abnormal display.

### SUMMARY OF INVENTION

In view of this, a liquid crystal display panel and a manufacturing method of same which can avoid a display mura and an abnormal display meanwhile prevent an array substrate and a color filter substrate from stripping are provided.

A liquid crystal display panel, comprises a first substrate defined as an array substrate;

a second substrate disposed opposite to the first substrate;

a liquid crystal layer disposed between the first substrate and the second substrate;

a sealant bonding the first substrate with the second substrate and sealing the liquid crystal layer; and

a light-shielding layer, wherein the light-shielding layer is located on a side of the second substrate away from the first substrate, the liquid crystal display panel comprises a display area and a non-display area, the light-shielding layer comprises a first part and a second part, the first part is located in the non-display area, and the second part is located in the display area.

In one embodiment, a color filter layer is disposed on the first substrate, the liquid crystal display panel is a vertical alignment type liquid crystal display panel with.

In one embodiment, the liquid crystal display panel further comprises an optical film layer, the optical film is located on the side of the second substrate away from the first substrate, and the light-shielding layer is located between the second substrate and the optical film layer.

In one embodiment, the liquid crystal display panel further comprises an optical film layer, the optical film is located on the side of the second substrate away from the first substrate, the optical film is located between the second substrate and the light-shielding layer.

A manufacturing method of a liquid crystal display panel, comprises the steps:

a cell assembling step of providing a first substrate and a second substrate, filling a plurality of liquid crystals into space between the first substrate and the second substrate, for conducting cell assembly between the first substrate and the second substrate;

a sealant curing step of forming a sealant between the first substrate and the second substrate to surround the liquid crystals, and curing the sealant to form an intermediate product, wherein the intermediate product comprises a display area and a non-display area;

a light-shielding layer forming step of disposing a light-shielding material layer on a side of the second substrate away from the first substrate, and patterning the light-shielding material layer to form a first part and a second part, the first part is located in the non-display area, and the second part is located in the display area.

In one embodiment, the sealant curing step comprises steps of:

providing a first mask, and placing the first mask on the side of the second substrate away from the first substrate;

irradiating the second substrate with an ultraviolet light from a side of the first mask away from the second substrate to cure the sealant; and

removing the first mask.

In one embodiment, the manufacturing method further comprises an optical alignment step of the liquid crystals, and the optical alignment step of the liquid crystals comprises step of irradiating the second substrate with an ultraviolet light from the side of the second substrate away from the first substrate.

In one embodiment, in the light-shielding layer forming step, the light-shielding material layer is defined as a photoresist material; the light-shielding layer forming step comprises steps of:

providing a second mask, and placing the second mask on a side of the light-shielding material layer away from the first substrate;

irradiating the light-shielding material layer with an ultraviolet light from a side of the second mask away from the second substrate to cure the sealant; and

etching the light-shielding material layer to form a patterned light-shielding layer.

In one embodiment, the manufacturing method further comprises a step of configuring an optical film on the side of the second substrate away from the first substrate, and the light-shielding layer is located between the second substrate and the optical film layer.

In one embodiment, the manufacturing method further comprises a step of configuring an optical film on the side of the second substrate away from the first substrate, the optical film is located between the second substrate and the light-shielding layer.

In one embodiment, the first substrate is an array substrate while the second substrate is a color filter substrate.

In one embodiment, the first substrate is an array substrate, and a color filter layer is disposed on the first substrate, the liquid crystal display panel is a vertical alignment type liquid crystal display panel.

A liquid crystal display panel, comprises:

a first substrate defined as an array substrate;

a second substrate, wherein the second substrate is defined as a color filter substrate and is disposed opposite to the first substrate;

a liquid crystal layer disposed between the first substrate and the second substrate;

a sealant bonding the first substrate with the second substrate and sealing the liquid crystal layer; and

a light-shielding layer, wherein the light-shielding layer is located on a side of the second substrate away from the first substrate, the liquid crystal display panel comprises a display area and a non-display area, the light-shielding layer comprises a first part and a second part, the first part is located in the non-display area, and the second part is located in the display area.

In one embodiment, the liquid crystal display panel further comprises an optical film layer, the optical film is located on the side of the second substrate away from the first substrate, and the light-shielding layer is located between the second substrate and the optical film layer.

In one embodiment, the liquid crystal display panel further comprises an optical film layer, the optical film is located on the side of the second substrate away from the first substrate, the optical film is located between the second substrate and the light-shielding layer.

Compared to prior art, in the liquid crystal display panel and the manufacturing method of the same according to one embodiment of the present disclosure, by disposing the light-shielding layer on a surface of the second substrate away from the first substrate, incomplete curing due to the effect of the light-shielding layer on light irradiation conducted to the sealant can be prevented, so as to prevent display mura and abnormal display, as well as prevent the array substrate and the color filter substrate from stripping.

In addition, in the liquid crystal display panel and the manufacturing method of the same according to another embodiment of the present disclosure, by disposing the light-shielding layer on the surface of the second substrate away from the first substrate, incomplete reaction of monomers inside the liquid crystal layer due to the effect of the light-shielding layer on light irradiation conducted to the liquid crystal layer can be prevented, so as to prevent display mura and abnormal display.

### BRIEF DESCRIPTION OF DRAWINGS

In order to more clearly illustrate the technical solution of the present invention, a brief description of the drawings that are necessary for the illustration of the embodiments will be given as follows. Obviously, the drawings described below show only some embodiments of the present invention, and a person having ordinary skill in the art may also obtain other drawings based on the drawings described without making any creative effort.

FIG. 1 is a schematic plan view of a liquid crystal display panel provided by a first embodiment of the present disclosure.

FIG. 2 is a cross-sectional view of the liquid crystal display panel provided by the first embodiment of the present disclosure along A-A line of FIG. 1.

FIG. 3 is a cross-sectional view of a liquid crystal display panel provided by a second embodiment of the present disclosure.

FIG. 4 is a cross-sectional view of a liquid crystal display panel provided by a third embodiment of the present disclosure.

FIG. 5 is a cross-sectional view of a liquid crystal display panel provided by a fourth embodiment of the present disclosure.

FIG. 6(a) to FIG. 6(d) are schematic views of a manufacturing method of a liquid crystal display panel provided by a fifth embodiment of the present disclosure.

FIG. 7(a) to FIG. 7(e) are schematic views of a manufacturing method of a liquid crystal display panel provided by a sixth embodiment of the present disclosure.

### DETAILED DESCRIPTION OF PREFERRED EMBODIMENTS

The present disclosure is further described in detail below with reference to the accompanying drawings and embodiments. Obviously, the following described embodiments are only part of the present disclosure but not all. A person having ordinary skill in the art may obtain other embodiments based on the embodiments provided in the present disclosure without making any creative effort, which all belong to the scope of the present disclosure.

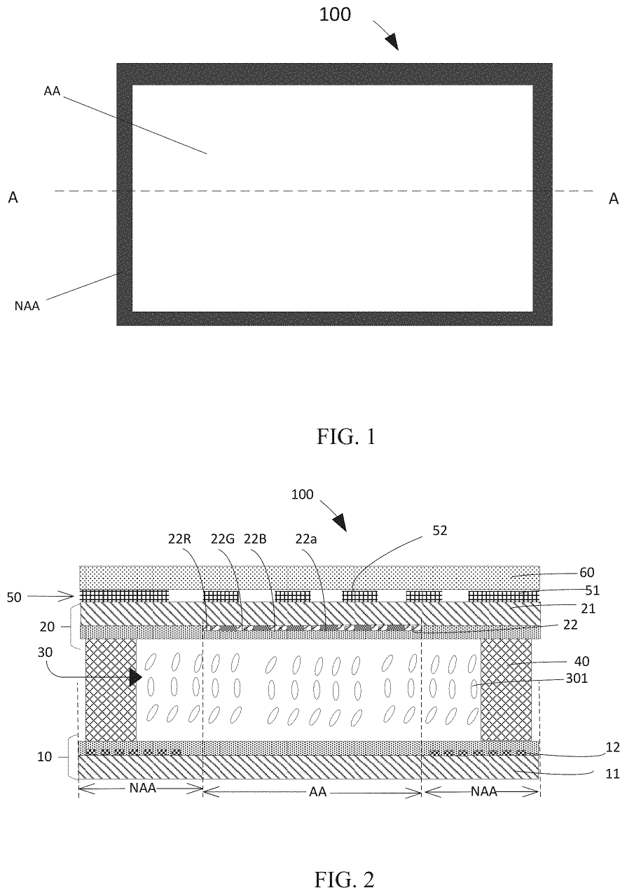

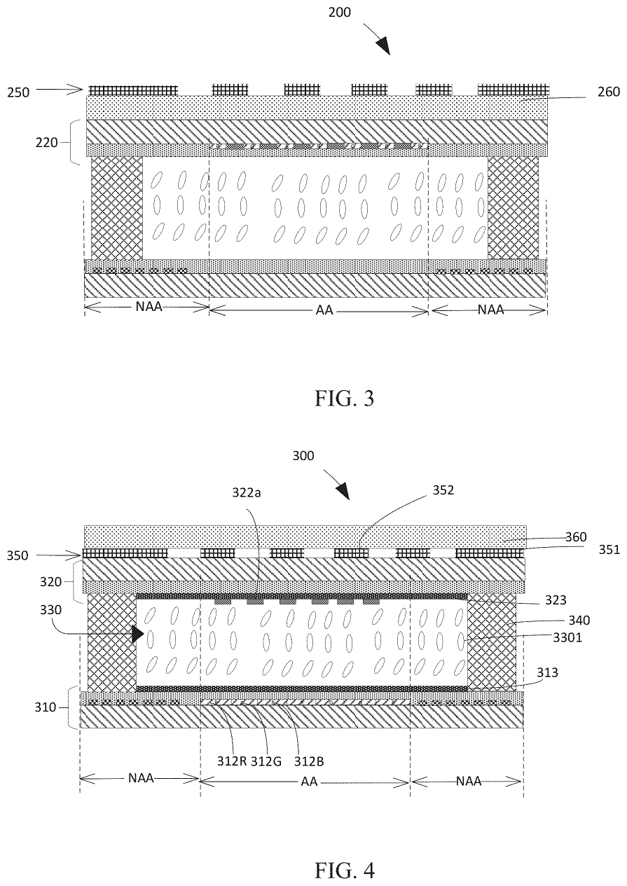

Referring to FIG. 1 and FIG. 2, a liquid crystal display panel 100 according to a first embodiment of the present disclosure can be used in small and medium-size display devices such as portable phones, PDAs, smart phones, car monitors, industrial displays, medical displays, etc., and large-size display devices such as televisions, electronic whiteboards, billboards, and so on. It can be used independently or integrated with touch module.

The liquid crystal display panel 100 includes a display area AA and a non-display area NAA surrounding the display area AA. The liquid crystal display panel 100 comprises a first substrate 10, a second substrate 20 disposed opposite to the first substrate 10; a liquid crystal layer 30 disposed between the first substrate 10 and the second substrate 20; and a sealant 40 bonding the first substrate 10 with the second substrate 20 and sealing the liquid crystal layer 30. A light-shielding layer 50 and an optical film 60 are located on a surface of the second substrate 20 away from the first substrate 10. The light-shielding layer 50 is located between the second substrate 20 and the optical film 60.

The first substrate 10 is defined as an array substrate and includes a first base substrate 11 and a plurality of metal traces 12 disposed on the first base substrate 11. The plurality of metal traces 12 are located in the non-display area NAA.

The first base substrate 11 is used to support other components of the first substrate 10. The first base substrate 11 could be glass substrate.

The plurality of metal traces 12 include but are not limited to source lines, gate lines, common electrode lines, and touch electrode lines.

Although not shown in the drawings, the first substrate 10 further comprises a plurality of thin film transistors (TFTs) arranged in a matrix which are disposed on the first base substrate 11, a plurality of scan lines, a plurality of data lines, a plurality of pixel electrodes, insulating layers, spacers, alignment films, passivation layers, source driver, drain driver, and other components for displaying.

The second substrate 20 is defined as a color filter substrate and includes a second base substrate 21 and a color filter layer 22 disposed on the second base substrate 21.

The second base substrate 21 is used to support other components of the second substrate 20. The second base substrate 21 could be glass substrate.

The color filter layer 22 is consisted of color filters 22R (red), 22G (green), and 22B (blue) arranged in sequence. Two adjacent color filters are separated by a black matrix 22a. A combination of colors of the color filter layer 22 is not specifically restricted. In addition to a combination of red, green, and blue as shown in the drawings, for example, a combination of red, green, blue, and yellow or white can also be listed.

Although not shown in FIGs, the second substrate 20 further includes components for displaying, such as a common electrode layer, a planarizing film, alignment films, and so on.

The sealant 40 is located in the non-display area NAA of the display device 100. The sealant 40 includes a resin material which is curable by light irradiation. Specifically, it may include a light curable resin material or a light and thermal dual curable resin material.

The light-shielding layer 50 includes a first part 51 located in the non-display area NAA and a second part 52 located in the display area AA. The first part 51 is used for light-shielding to the plurality of metal traces 12 and the sealant 40, etc., to prevent light leakage from the non-display area NAA. The second part 52 is used to shield light leaked from gaps of multiple metal layers formed on the first substrate 10 to prevent light leakage during black display state. It should be noted that FIG. 1 only shows the display device during white display state. Thus, the second part 52 is difficult to observe by the naked eye. On the other hand, FIG. 2 only shows a schematic view of the first part 51 and the second part 52, and does not represent an actual scale of both. In addition, the light-shielding layer 50 may be made of a black resin material. In an embodiment of the present disclosure, it can be made of the same material as the black matrix 22a.

The optical film 60 may have functions of improving color deviation and light extraction, etc. The optical film 60 includes but is not limited to one or more of a polarizing film, a phase difference film, a brightening film, a reflecting film, a light absorbing film, etc.

Although a vertical alignment type liquid crystal display panel is shown in FIG. 2, in another embodiment of the present disclosure, the liquid crystal display panel 100 can also be a horizontal alignment liquid crystal display panel, for example, an IPS (in plane switching) liquid crystal display panel or an FFS (fringe field switching) liquid crystal display panel. Under this circumstance, the common electrode layer is disposed on the first substrate 10.

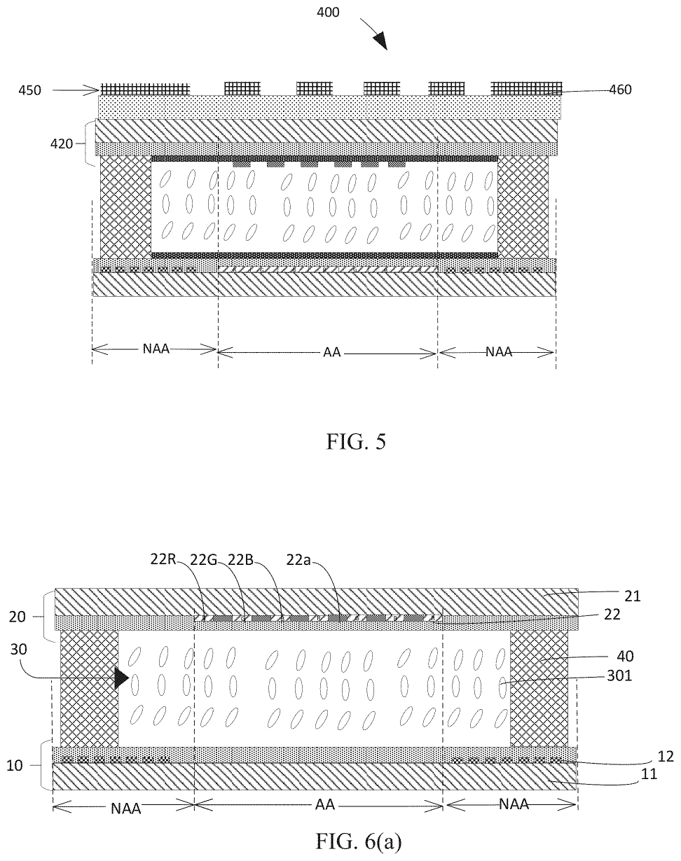

Please refer to FIG. 3, FIG. 3 shows a liquid crystal display panel 200 according to another embodiment of the present disclosure. The liquid crystal display panel 200 is substantially the same as the first embodiment, except that an optical film 260 is located between a second substrate 220 and a light-shielding layer 250.

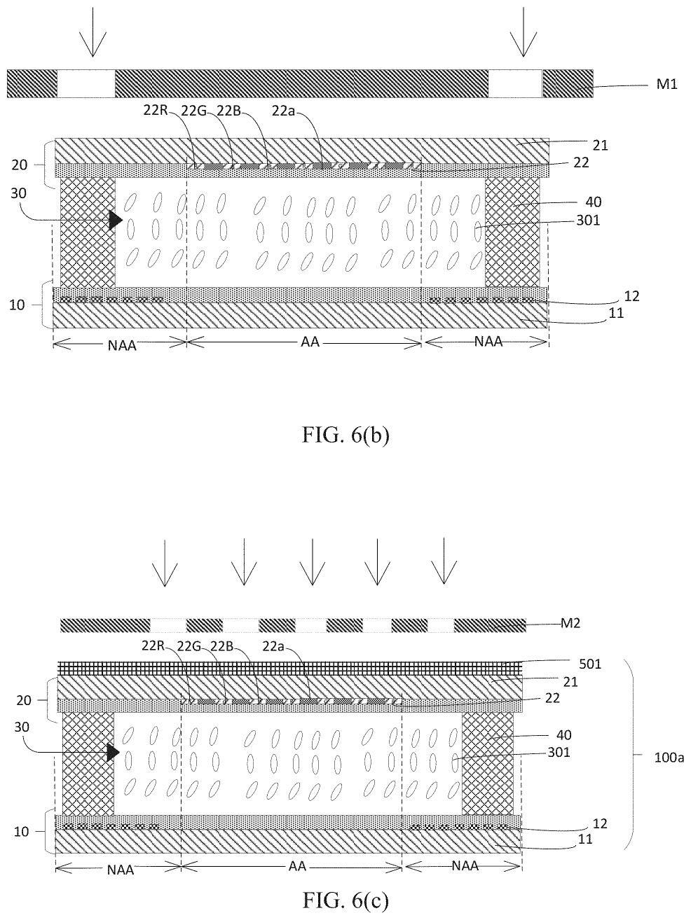

Please refer to FIG. 4, a liquid crystal display panel 300 is provided by a third embodiment of the present disclosure. The liquid crystal display panel 300 is substantially the same as the liquid crystal display panel 100 according to the first embodiment, except that:

the liquid crystal display panel 300 is a color filter on array (COA) type liquid crystal display panel of. The color filters 312R (red), 312G (green), and 312B (blue) are arranged in sequence on a first substrate 310. A black matrix 322a and spacers (not shown) are located on a second substrate 320 disposed opposite to the first substrate 310.

In addition, in the liquid crystal display panel 300, a sealant 340 may include a light curable resin material or a thermal curable resin material. Specifically, it may include the light curable resin material, the thermal curable resin material or a light and thermal dual curable resin material.

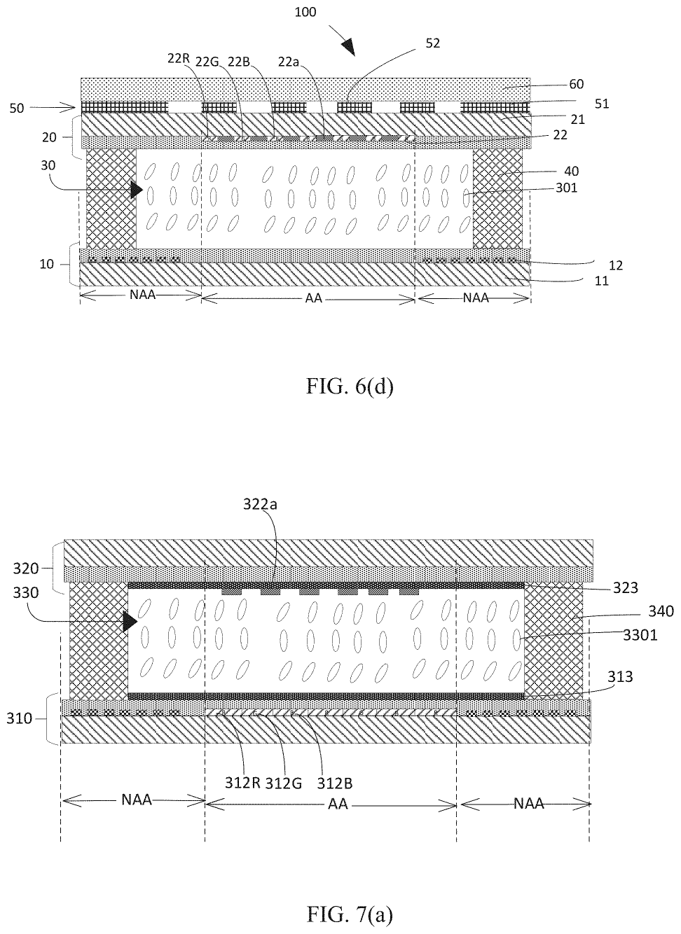

Please refer to FIG. 5, FIG. 5 shows a cross-sectional view of a liquid crystal display panel 400 according to another embodiment of the present disclosure. The liquid crystal display panel 400 is substantially the same as the liquid crystal display panel 100 according to the third embodiment, except that an optical film 460 is located between a second substrate 420 and a light-shielding layer 450.

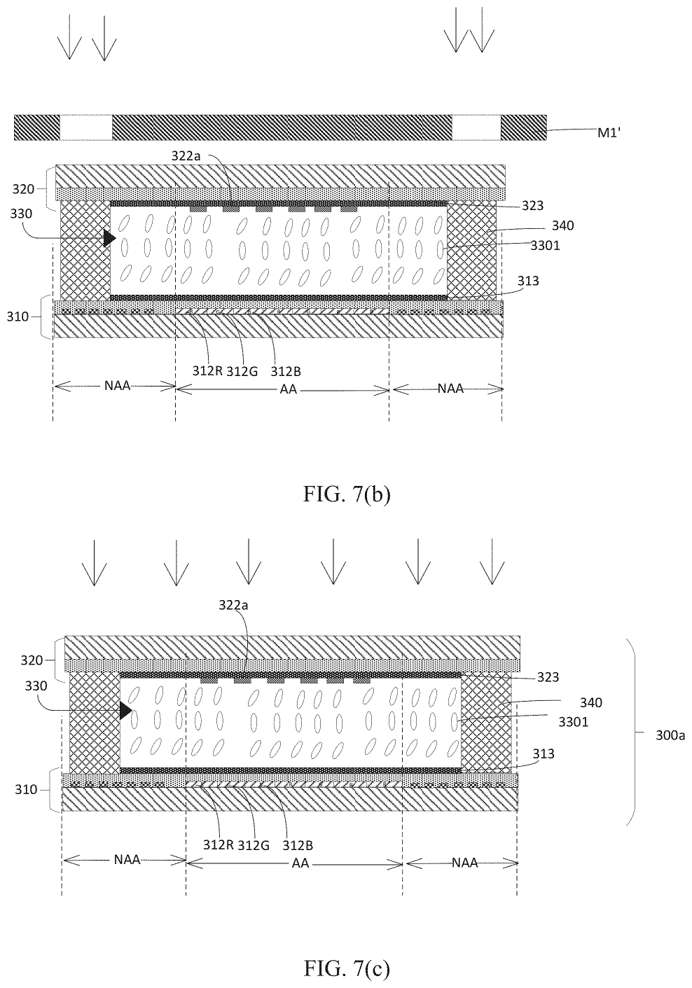

Please refer to FIGS. 6(a) to 6(d), a manufacturing method of a liquid crystal display panel 100 is provided by a fifth embodiment of the present disclosure, comprising the following steps.

(a) A cell assembling step shown in FIG. 6(a) of providing a first substrate 10 and a second substrate 20, filling a plurality of liquid crystals 301 into space between the first substrate 10 and the second substrate 20 to form a liquid crystal layer 30, for conducting cell assembly between the first substrate 10 and the second substrate 20.

(b) A sealant curing step shown in FIG. 6(b) of forming a sealant 40 between the first substrate 10 and the second substrate 20 to surround the liquid crystal layer 30, and curing the sealant 40 by a light irradiation. The sealant 40 bonds the first substrate 10 and the second substrate 20 and seals the liquid crystal layer 30 to form an intermediate product 100a. The intermediate product 100a comprises a display area AA and a non-display area NAA.

Specifically, providing a first mask M1, and placing the first mask M1 on a side of the second substrate 20 away from the first substrate 10;

irradiating the second substrate 20 with an ultraviolet light from a side of the first mask M1 away from the second substrate 20 to cure the sealant 40; and

removing the first mask M1.

(c) A light-shielding layer forming step shown in FIG. 6(c) of disposing a light-shielding material layer 501 on a side of the second substrate 20 away from the first substrate 10, and patterning the light-shielding material layer 501 to form a first part 51 and a second part 52, the first part 51 is located in the non-display area NAA, and the second part 52 is located in the display area AA.

Specifically, the light-shielding material layer 501 can consist of a photoresist material. The light-shielding layer forming step comprises steps of:

providing a second mask M2, and placing the second mask M2 on a side of the light-shielding material layer 501 away from the first substrate 10;

irradiating the light-shielding material layer 501 with an ultraviolet light from a side of the second mask M2 away from the second substrate 20; and

etching the light-shielding material layer 501 to form a patterned light-shielding layer 50.

(d) An optical film forming step shown in FIG. 6(d) of forming an optical film 60 on the side of the second substrate 20 away from the first substrate 10.

As the structure and materials of the liquid crystal display panel 100 are the same as the first embodiment, description thereof is omitted here.

In addition, the liquid crystal display panel according to the second embodiment of the present disclosure can also be manufactured by the same method, and only an order interchange of the light-shielding layer forming step and the optical film forming step is required.

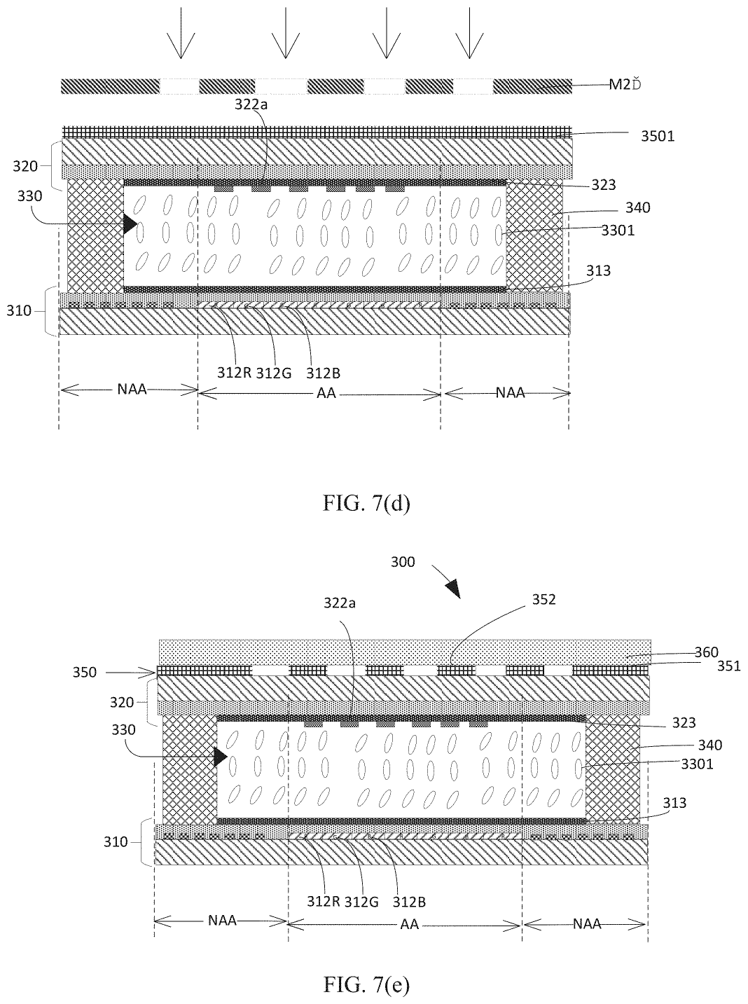

Please refer to FIGS. 7(a) to 7(e), a method of manufacturing a liquid crystal display panel 300 is provided by a sixth embodiment of the present disclosure, comprising the following steps.

(a) A cell assembling step shown in FIG. 7(a) of providing a first substrate 310 and a second substrate 320, filling a plurality of liquid crystals 3301 into space between the first substrate 310 and the second substrate 320 to form a liquid crystal layer 330, for conducting cell assembly between the first substrate 310 and the second substrate 320.

(b) A sealant curing step shown in FIG. 7(b) of forming a sealant 340 between the first substrate 310 and the second substrate 320 to surround the liquid crystal layer 330, and curing the sealant 340 by a light irradiation. The sealant 340 bonds the first substrate 310 and the second substrate 320 and seals the liquid crystal layer 330 to form an intermediate product 300a. The intermediate product 300a comprises a display area AA and a non-display area NAA.

Specifically, providing a first mask M1′, and placing the first mask M1′ on a side of the second substrate 320 away from the first substrate 310;

irradiating the second substrate 320 with an ultraviolet light from a side of the first mask M1′ away from the second substrate 320 to cure the sealant 340; and

removing the first mask M1′.

(c) An optical alignment step of liquid crystals shown in FIG. 7(c), and the optical alignment step of liquid crystals comprises steps of irradiating the second substrate 320 with an ultraviolet light from the side of the second substrate 320 away from the first substrate 310.

(d) A light-shielding layer forming step shown in FIG. 7(d) of disposing a light-shielding material layer 3501 on a side of the second substrate 320 away from the first substrate 310, and patterning the light-shielding material layer 3501 to form a first part 351 and a second part 352, the first part 351 is located in the non-display area NAA, and the second part 352 is located in the display area AA.

Specifically, the light-shielding material layer 3501 can consist of a photoresist material. The light-shielding layer forming step comprises steps of:

providing a second mask M2′, and placing the second mask M2′ on a side of the light-shielding material layer 3501 away from the first substrate 310;

irradiating the light-shielding material layer 3501 with a light from a side of the second mask M2′ away from the second substrate 320; and

etching the light-shielding material layer 3501 to form a patterned light-shielding layer 350.

(e) An optical film forming step shown in FIG. 7(e) of forming an optical film 360 on a side of the light-shielding layer 350 away from the second substrate 320.

As the structure and materials of the liquid crystal display panel 300 are the same as the third embodiment, description thereof is omitted here.

In addition, the liquid crystal display panel according to the fourth embodiment of the present disclosure can also be manufactured by the same method, and only an order interchange of the light-shielding layer forming step and the optical film layer forming step is required.

Compared to the prior art, in the liquid crystal display panel and the manufacturing method of the same of the present disclosure, by disposing the light-shielding layer on a surface of the second substrate away from the first substrate, incomplete curing due to the effect of the light-shielding layer on light irradiation conducted to the sealant can be prevented, so as to prevent display mura and abnormal display, as well as prevent the array substrate and the color filter substrate from stripping.

In addition, in the liquid crystal display panel and the manufacturing method of the same according to another embodiment of the present disclosure, by disposing the light-shielding layer on a surface of the second substrate away from the first substrate, incomplete reaction of monomers inside the liquid crystal layer due to the effect of the light-shielding layer on light irradiation conducted to the liquid crystal layer can be prevented, so as to prevent display mura and abnormal display.

A detailed description of a display panel and a manufacturing method of a display panel provided by embodiments of the present disclosure is illustrated above. The description of the above embodiments is only intended to help understand the technical schemes and core concepts of the present disclosure. It is noted that those with ordinary skill in the field could make various modifications to the technical schemes described in embodiments above-mentioned, and these modifications and replacements do not make the essence of the corresponding technical schemes depart from the scope of technical schemes of embodiments of the present disclosure.

What is claimed is:

1. A liquid crystal display panel, comprising:
a first substrate defined as an array substrate;
a second substrate disposed opposite to the first substrate;
a liquid crystal layer disposed between the first substrate and the second substrate;
a sealant bonding the first substrate with the second substrate and sealing the liquid crystal layer; and
a light-shielding layer, wherein the light-shielding layer is located on a side of the second substrate away from the first substrate, the liquid crystal display panel comprises a display area and a non-display area, the light-shielding layer comprises a first part and a second part, the first part is located in the non-display area, and the second part is located in the display area.

2. The liquid crystal display panel of claim 1, wherein a color filter layer is disposed on the first substrate, and the liquid crystal display panel is a vertical alignment type liquid crystal display panel.

3. The liquid crystal display panel of claim 1, wherein the liquid crystal display panel further comprises an optical film layer, the optical film is located on the side of the second substrate away from the first substrate, and the light-shielding layer is located between the second substrate and the optical film layer.

4. The liquid crystal display panel of claim 2, wherein the liquid crystal display panel further comprises an optical film layer, the optical film is located on the side of the second substrate away from the first substrate, and the light-shielding layer is located between the second substrate and the optical film layer.

5. The liquid crystal display panel of claim 1, wherein the liquid crystal display panel further comprises an optical film layer, the optical film is located on the side of the second substrate away from the first substrate, and the optical film is located between the second substrate and the light-shielding layer.

6. The liquid crystal display panel of claim 2, wherein the liquid crystal display panel further comprises an optical film layer, the optical film is located on the side of the second substrate away from the first substrate, and the optical film is located between the second substrate and the light-shielding layer.

7. A manufacturing method of a liquid crystal display panel, comprising steps of:
a cell assembling step of providing a first substrate and a second substrate, filling a plurality of liquid crystals into space between the first substrate and the second substrate, for conducting cell assembly between the first substrate and the second substrate;
a sealant curing step of forming a sealant between the first substrate and the second substrate to surround the liquid crystals, and curing the sealant to form an intermediate product, wherein the intermediate product comprises a display area and a non-display area; and
a light-shielding layer forming step of disposing a light-shielding material layer on a side of the second substrate away from the first substrate, and patterning the light-shielding material layer to form a first part and a second part, wherein the first part is located in the non-display area, and the second part is located in the display area.

8. The manufacturing method of claim 7, wherein the sealant curing step comprises steps of:
providing a first mask, and placing the first mask on the side of the second substrate away from the first substrate;
irradiating the second substrate with an ultraviolet light from a side of the first mask away from the second substrate to cure the sealant; and
removing the first mask.

9. The manufacturing method of claim 7, wherein the manufacturing method further comprises an optical alignment step of the liquid crystals, and the optical alignment step of the liquid crystals comprises step of irradiating the second substrate with an ultraviolet light from the side of the second substrate away from the first substrate.

10. The manufacturing method of claim 7, wherein in the light-shielding layer forming step, the light-shielding material layer is defined as a photoresist material;
the light-shielding layer forming step comprises steps of:
providing a second mask, and placing the second mask on a side of the light-shielding material layer away from the first substrate;
irradiating the light-shielding material layer with a light from a side of the second mask away from the second substrate to cure the sealant; and
etching the light-shielding material layer to form a patterned light-shielding layer.

11. The manufacturing method of claim 7, wherein the manufacturing method further comprises an optical film forming step of forming an optical film on the side of the second substrate away from the first substrate, and the light-shielding layer is located between the second substrate and the optical film layer.

12. The manufacturing method of claim 7, wherein the manufacturing method further comprises an optical film forming step of forming an optical film on the side of the second substrate away from the first substrate, and the optical film is located between the second substrate and the light-shielding layer.

13. The manufacturing method of claim 7, wherein the first substrate is an array substrate, and the second substrate is a color filter substrate.

14. The manufacturing method of claim 7, wherein the first substrate is an array substrate, a color filter layer is disposed on the first substrate, and the liquid crystal display panel is a vertical alignment type liquid crystal display panel.

15. A liquid crystal display panel, comprising:
a first substrate defined as an array substrate;
a second substrate, wherein the second substrate is defined as a color filter substrate and is disposed opposite to the first substrate;
a liquid crystal layer disposed between the first substrate and the second substrate;
a sealant bonding the first substrate with the second substrate and sealing the liquid crystal layer; and
a light-shielding layer, wherein the light-shielding layer is located on a side of the second substrate away from the first substrate, the liquid crystal display panel comprises a display area and a non-display area, the light-shielding layer comprises a first part and a second part, the first part is located in the non-display area, and the second part is located in the display area.

16. The liquid crystal display panel of claim 15, wherein the liquid crystal display panel further comprises an optical film layer, the optical film is located on the side of the second substrate away from the first substrate, and the light-shielding layer is located between the second substrate and the optical film layer.

17. The liquid crystal display panel of claim 15, wherein the liquid crystal display panel further comprises an optical film layer, the optical film is located on the side of the second substrate away from the first substrate, and the optical film is located between the second substrate and the light-shielding layer.
